(19) United States
(12) Patent Application Publication
(10) Pub. No.: US 2022/0366802 A1
(43) Pub. Date: Nov. 17, 2022

(54) FLYING OBJECT MANAGEMENT APPARATUS, FLYING OBJECT MANAGEMENT METHOD, AND RECORDING MEDIUM

(71) Applicant: NEC CORPORATION, Minato-ku, Tokyo (JP)

(72) Inventors: Hideaki SATO, Tokyo (JP); Kyota Higa, Tokyo (JP)

(73) Assignee: NEC Corporation, Minato-ku, Tokyo (JP)

(21) Appl. No.: 17/785,120

(22) PCT Filed: Dec. 27, 2019
(86) PCT No.: PCT/JP2019/051505

§ 371 Date: Jun. 14, 2022

(51) Int. Cl. G08G 5/04; G08G 5/00

(52) U.S. Cl. CPC G08G 5/045; G08G 5/0026; G08G 5/003; G08G 5/0082; G08G 5/0069

(57) ABSTRACT

In a flying object management apparatus, a flight plan acquisition unit acquires a flight plan of a managed flying object which is a flying object to be managed. An information acquisition unit acquires information of an unmanaged flying object which is a flying object other than the managed flying object. A determination unit determines a possibility of collision between the unmanaged flying object and the managed flying object based on information of the unmanaged flying object and the flight plan. A display unit displays a warning image including the unmanaged flying object having the possibility of collision.

### TECHNICAL FIELD

The present disclosure relates to a technique for managing a status of a flying object.

### BACKGROUND ART

In recent years, drones have been utilized for various applications. In a case where the drones have become popularly used, it is considered that an air traffic control of the drones will be necessary. For example, it is necessary to monitor surroundings of the drones to be managed using images taken by cameras installed on the ground. Specifically, in an aviation control work of drones, it is necessary to detect small moving objects based on captured images, to identify uncontrollable objects such as birds and drones other than managed drones, and to automatically perform collision avoidance by immediately controlling the drones to be managed.

Patent Document 1 describes a control support system for performing collision avoidance of an aircraft.

### PRECEDING TECHNICAL REFERENCES

### Patent Document

International Publication Pamphlet No. WO2014/156169

### SUMMARY

### Problem to be Solved by the Invention

Patent Document 1 describes a method for proposing an optimal collision avoidance measure based on a flight plan of an aircraft. However, since there is no flight plan for birds or unmanaged drones that can be subject to collision in a control of drones, drones that may be in the collision cannot be reduced, and it is difficult to propose avoidance measures.

It is an object of the present disclosure to avoid collision of a flying object to be managed with other flying objects such as birds or unmanaged drones.

### Means for Solving the Problem

According to an example aspect of the present disclosure, there is provided a flying object management apparatus including:

a flight plan acquisition unit configured to acquire a flight plan of a managed flying object being a flying object to be managed;

an information acquisition unit configured to acquire information of an unmanaged flying object being a flying object other than the managed flying object;

a determination unit configured to determine a possibility of collision between the unmanaged flying object and the managed flying object based on the information of the unmanaged flying object and the flight plan; and

a display unit configured to display a warning image including the unmanaged flying object having the possibility of collision.

According to another example aspect of the present disclosure, there is provided a flying object management method including:

acquiring a flight plan of a managed flying object being a flying object to be managed;

acquiring information of an unmanaged flying object being a flying object other than the managed flying object;

determining a possibility of collision between the unmanaged flying object and the managed flying object based on the information of the unmanaged flying object and the flight plan; and

displaying a warning image including the unmanaged flying object having the possibility of collision.

According to still another example aspect of the present disclosure, there is provided a recording medium storing a program, the program causing a computer to perform a process including:

acquiring a flight plan of a managed flying object being a flying object to be managed;

acquiring information of an unmanaged flying object being a flying object other than the managed flying object;

determining a possibility of collision between the unmanaged flying object and the managed flying object based on the information of the unmanaged flying object and the flight plan; and

displaying a warning image including the unmanaged flying object having the possibility of collision.

### Effect of the Invention

According to the present disclosure, it is possible to avoid collision of a flying object to be managed with other flying objects such as birds or unmanaged drones.

### BRIEF DESCRIPTION OF THE DRAWINGS

FIG. 1 illustrates a functional configuration of a drone control system according to a first example embodiment of the present disclosure.

FIG. 2 illustrates a hardware configuration of a drone management apparatus.

FIG. 3A and FIG. 3B illustrate examples of a flight plan.

FIG. 4A and FIG. 4B illustrate examples of unmanaged object information.

FIG. 5 is a diagram for explaining a determination method of a possibility of collision.

FIG. 6A and FIG. 6B are diagrams for explaining a creation method of a third person perspective image.

FIG. 7A and FIG. 7B illustrate examples of display images.

FIG. 8 is a flowchart of a collision avoidance process.

FIG. 9A and FIG. 9B illustrate other examples of the display images.

FIG. 10A and FIG. 10B illustrate other examples of the display images.

FIG. 11 illustrates a functional configuration of a flying object management apparatus according to a second example embodiment.

### EXAMPLE EMBODIMENTS

In the following, example embodiments will be described with reference to the accompanying drawings. The following example embodiments illustrate examples of applying a flying object management apparatus of the present disclosure to a drone control system. The term “managed flying object” as a subject to be managed in this disclosure refers to an unmanned flying object which flies under an external control or which flies autonomously based on a program set in advance therein, and which excludes a flying object which are operated by a person on board such as an airplane or a helicopter. However, a managed flying object may be a cargo-carrying object, and a person may appear if the person is a passenger rather than a pilot. The following example embodiments describe a system for managing a drone as a typical example of a managed flying object.

### First Example Embodiment

[Drone Control System]

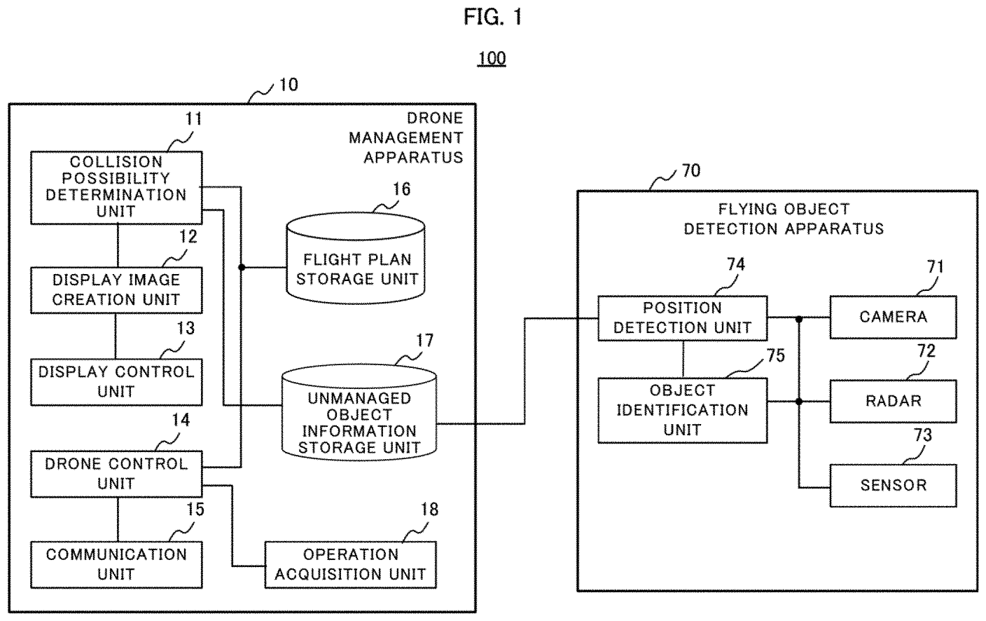

FIG. 1 is a block diagram illustrating a functional configuration of a drone control system according to a first example embodiment of the present disclosure. The drone control system 100 includes a drone management apparatus 10 and a flying object detection apparatus 70. The drone management apparatus 10 manages and controls a flight of a drone to be managed (hereinafter referred to as a “managed drone”). Specifically, the drone management apparatus 10 manages and controls the managed drone so as not to cause collision between an unmanaged flying object flying in a range of a predetermined distance from the unmanaged drone (hereinafter, referred to as a “periphery”). The flying object detection apparatus 70 detects an unmanaged flying object flying around the managed drone. The “unmanaged flying object” is, for example, a bird, a drone other than the managed drone, that is, a drone uncontrollable by the drone control system 100.

[Flying Object Detection Apparatus]

First, the flying object detection apparatus will be described. The flying object detection apparatus 70 includes a camera 71, a radar 72, a sensor 73, a position detection unit 74, and an object identification unit 75. The camera 71 is installed on the ground, and captures images of the sky. The radar 72 is installed on the ground, and detects a flying object in the sky. The sensor 73 detects a flying object in the sky using, for example, ultrasonic sound waves or infrared rays. Detection signals of the camera 71, the radar 72, and the sensor 73 are input to the position detection unit 74 and the object identification unit 75. The position detection unit 74 detects a current position of the flying object based on these detection signals. The object identification unit 75 mainly identifies the flying object based on the captured image by the camera 71, and outputs an identification result to the position detection unit 74. Specifically, the object identification unit 75 identifies whether the flying object is a bird, a drone, an airplane, or the like. The position detection unit 74 supplies, as information of unmanaged flying objects, position information, a detection time, and the like for each unmanaged flying object other than the managed drone among the detected flying objects to the drone management apparatus 10 as unmanaged object information.

Note that, in addition to detecting the flying object using the camera, the radar, or the like as described above, the flying object detection apparatus 70 may acquire information of the flying object from other managed drones or the like. For example, each managed drone may detect the flying object existing in the periphery, and provide information such as a position, a detection time, and the like of the detected flying object to the flying object detection apparatus 70. In addition, a patrol drone or the like for the purpose of detecting an unmanaged flying object may be made to fly, and the information of the detected flying object may be provided to the flying object detection apparatus 70.

[Drone Management Apparatus]

Next, the drone management apparatus will be described.

(Hardware Configuration)

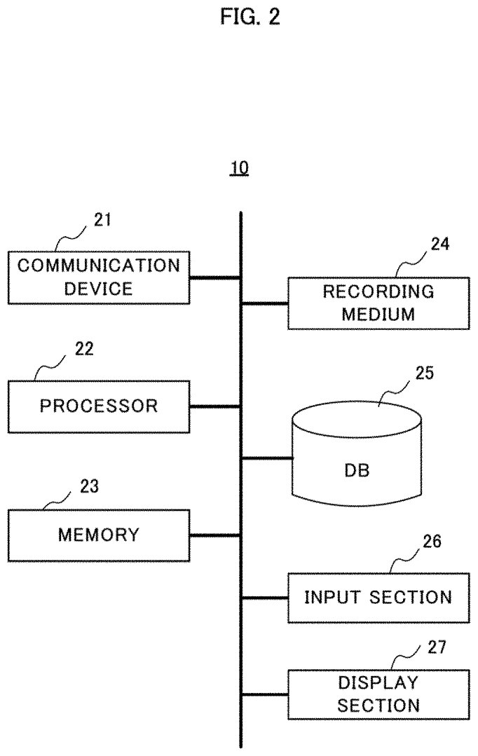

FIG. 2 is a block diagram illustrating a hardware configuration of the drone management apparatus 10. As illustrated, the drone management apparatus 10 includes a communication device 21, a processor 22, a memory 23, a recording medium 24, a database (DB) 25, an input section 26, and a display section 27.

The communication device 21 communicates with the managed drone. The processor 22 is a computer such as a CPU (Central Processing Unit), and controls the entire drone management apparatus 10 by executing programs prepared in advance. Specifically, the processor 22 executes a process for displaying a display image on the display section 27, and a collision avoidance process which will be described later.

The memory 23 is formed by a ROM (Read Only Memory), a RAM (Random Access Memory), and the like. The memory 23 stores various programs to be executed by the processor 22. The memory 23 is also used as a working memory during executions of various processes by the processor 22.

The recording medium 24 is a non-volatile and non-transitory recording medium such as a disk-shaped recording medium or a semiconductor memory, and is formed to be detachable from the drone management apparatus 10. The recording medium 24 records various programs executed by the processor 22. When the drone management apparatus 10 performs various kinds of processes, respective programs recorded on the recording medium 24 are loaded into the memory 23 and executed by the processor 22.

The database (DB) 25 stores data input from an external apparatus. Specifically, the database 25 stores flight plans of the managed drone and the unmanaged object information generated by the flying object detection apparatus 70. The input unit 26 is a keyboard, a mouse, various buttons, a lever, and the like for a user (controller) who controls the drone to perform instructions and inputs. The display section 27 is, for example, a liquid crystal display device, and displays a bird's-eye view image showing positions of the managed drone and the unmanaged flying object that is flying the periphery of the managed drone, a third person perspective image of the managed drone, and the like.

(Functional Configuration)

As illustrated in FIG. 1, the drone management apparatus 10 includes a collision possibility determination unit 11, a display image creation unit 12, a display control unit 13, a drone control unit 14, a communication unit 15, a flight plan storage unit 16, an unmanaged object information storage unit 17, and an operation acquisition unit 18.

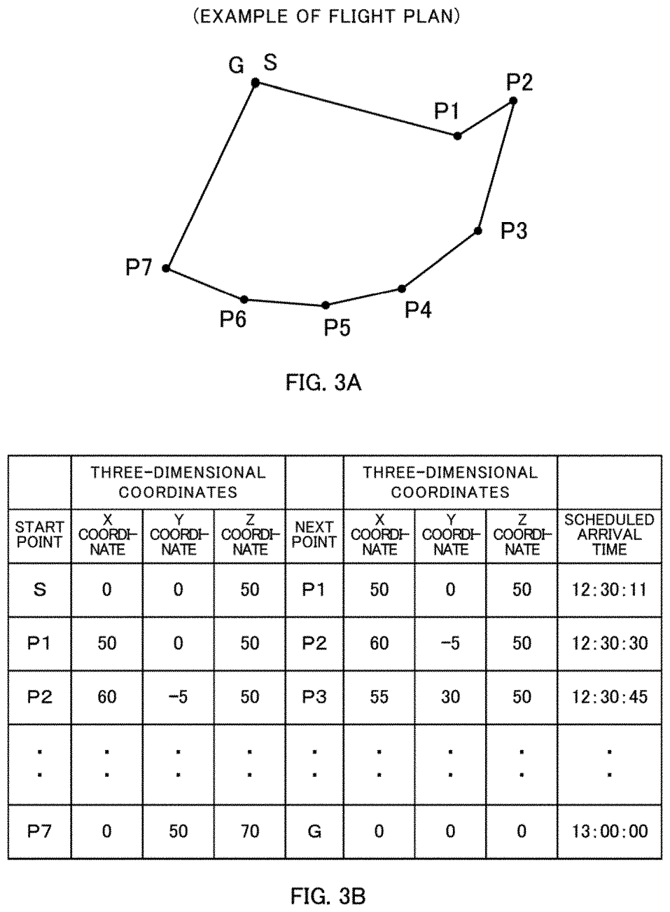

The flight plan storage unit 16 stores the flight plan set for each managed drone. FIG. 3A and FIG. 3B illustrate examples of the flight plan. FIG. 3A schematically depicts an example of a flight route in accordance with the flight plan. In this flight plan, the managed drone will start a flight from a take-off point S and land at a landing point G through points P1 to P7 in order. In this example, the take-off point S and the landing point G are the same point.

FIG. 3B illustrates an example of the flight plan stored in the flight plan storage unit 16. Incidentally, FIG. 3B corresponds to the flight plan for flying the flight route depicted in FIG. 3A. The flight plan is prepared from a certain point (start point) to a next point as one section, and includes three-dimensional coordinates of the start point and three-dimensional coordinates of time points, and a scheduled arrival time to the next point for each section. The flight plan as depicted in FIG. 3B is prepared for each flight of each managed drone and stored in the flight plan storage section 16.

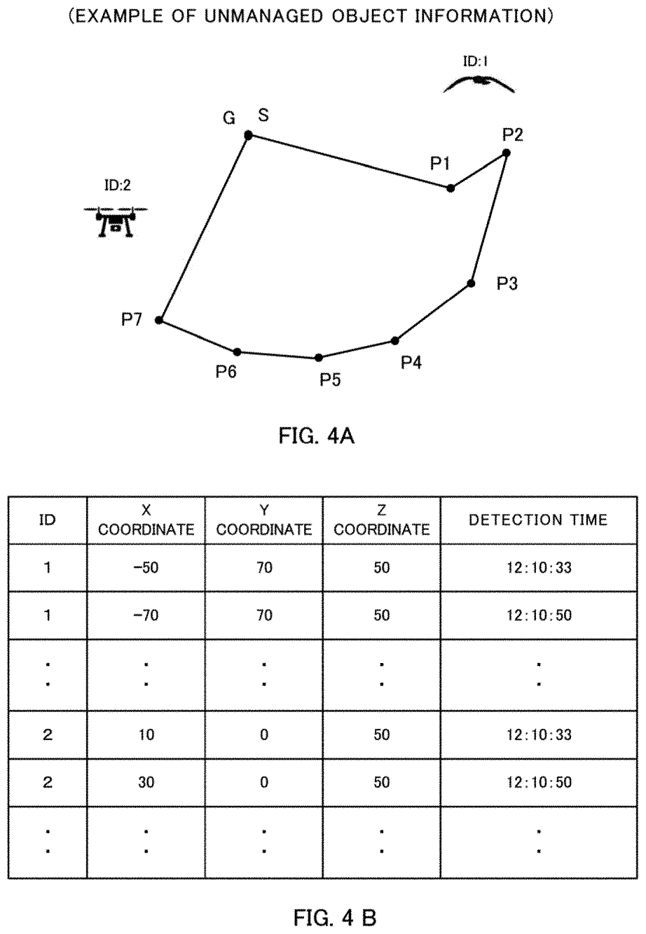

The unmanaged object information storage unit 17 stores unmanaged object information generated by the flying object detection apparatus 70. FIG. 4A and FIG. 4B illustrate examples of the unmanaged object information. As depicted in FIG. 4A, it is assumed that a bird (ID: 1) and an unmanaged drone (ID: 2) are flying as unmanaged flying objects around the flight route of the managed drone. FIG. 4B illustrates an example of the unmanaged object information in this case. The unmanaged object information includes an identification information (ID), three-dimensional coordinates, and detection time for each unmanaged flying object. In the example of FIG. 4B, respective three-dimensional coordinates of detected positions and respective detection times are stored for the bird (ID: 1) and the unmanaged drone (ID: 2). The flying object detection apparatus 70 constantly monitors a predetermined detection range, and supplies the unmanaged object information to the unmanaged object information storage unit 17 of the drone management apparatus 10 when detecting the unmanaged flying object. Accordingly, the unmanaged object information storage unit 17 is constantly updated with latest information. Moreover, information stored in the unmanaged object information storage unit 17 is retained for a predetermined time.

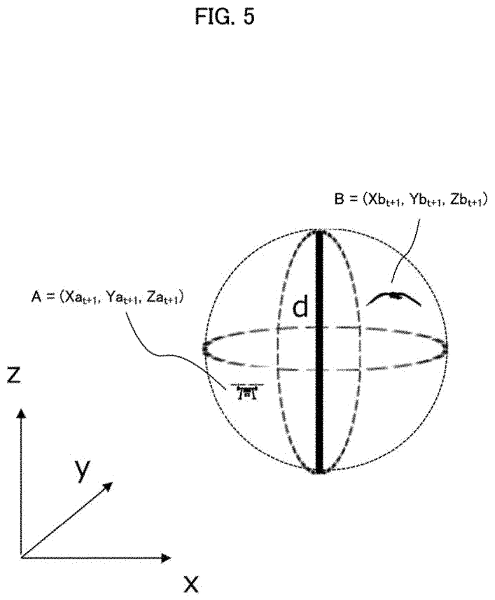

The collision possibility determination unit 11 determines a possibility of collision between the managed drone and the unmanaged flying object based on the flight plan stored in the flight plan storage unit 16 and the unmanaged object information stored in the unmanaged object information storage unit 17. FIG. 5 is a diagram illustrating a determination method of the collision possibility. The collision possibility determination unit 11 determines that there is the collision possibility when a distance between the managed drone and the unmanaged flying object is equal to or less than a predetermined distance d (hereinafter, also referred to as a “warning distance”). Note that the collision possibility determination unit 11 determines one or more avoidance plans based on a positional relationship between the managed drone and the unmanaged flying object having the possibility of collision.

FIG. 5 illustrates an area where the managed drone flies in a world coordinate system xyz. Now, it is assumed that the managed drone is denoted by “A”, and a bird, which is regarded as an unmanaged flying object, is denoted by “B”. Moreover, in a case where a subscript at a current time is denoted by “t”, the subscript at a previous time is denoted by “t−1”, and the subscript at a next time is denoted by “t+1”, a X coordinate of the managed drone A at the current time is denoted by “Xaₜ”, and the X coordinate at the next time is denoted by “Xaₜ₊₁”. Furthermore, the current time is “Tₜ”, and the previous time is “Tₜ₋₁”. In this case, the X coordinate Xaₜ₊₁ at the next time of the managed drone A is given by the following equation.

Xaₜ₊₁=Xaₜ+(Xaₜ−Xaₜ₋₁)/(Tₜ−Tₜ₋₁) (1)

Here, a second term on a right side represents speed of the managed drone A from the previous time to the current time. Therefore, the equation (1) indicates a X coordinate of a position where the managed drone A is expected to reach at the next time in a case where the managed drone A maintains a current traveling direction and a current speed. Similarly, the collision probability determination unit 11 calculates a Y coordinate Yaₜ₊₁ and a Z coordinate Zaₜ₊₁ of the managed drone A at the following time. Accordingly, the collision possibility determination unit 11 calculates three-dimensional coordinates for a predicted position of the managed drone A at the next time.

Similarly, a X-coordinate Xbₜ₊₁ of the unmanaged flying object B at the next time is acquired as follows:

Xbₜ₊₁=Xbₜ+(Xbₜ−Xbₜ₋₁)/(Tₜ−Tₜ₋₁) (2).

Similarly, the collision probability determination unit 11 calculates a Y coordinate Ybₜ₊₁ and a Z coordinate Zbₜ₊₁ of the unmanaged flying object B at the next time. Accordingly, the collision possibility determination unit 11 calculates three-dimensional coordinates of the managed drone A at the next time.

After that, the collision possibility determination unit 11 obtains a distance Dₜ₊₁ between the predicted position of the managed drone A and the predicted position of the unmanaged flying object B at the next time based on these three-dimensional coordinates, and when the distance Dₜ₊₁ is smaller than a warning distance d, that is, the following expression is satisfied;

Dₜ₊₁<d (3),

it is determined that there is a possibility of collision between the managed drone A and the unmanaged flying object B. Note that a state in which there is the possibility of collision is also referred to as a “warning state” hereafter in a sense of a state of warning that there is the possibility of collision. Accordingly, the collision possibility determination unit 11 outputs a combination of the managed drone and the unmanaged flying object, which are determined to be likely to collide, to the display image creation unit 12.

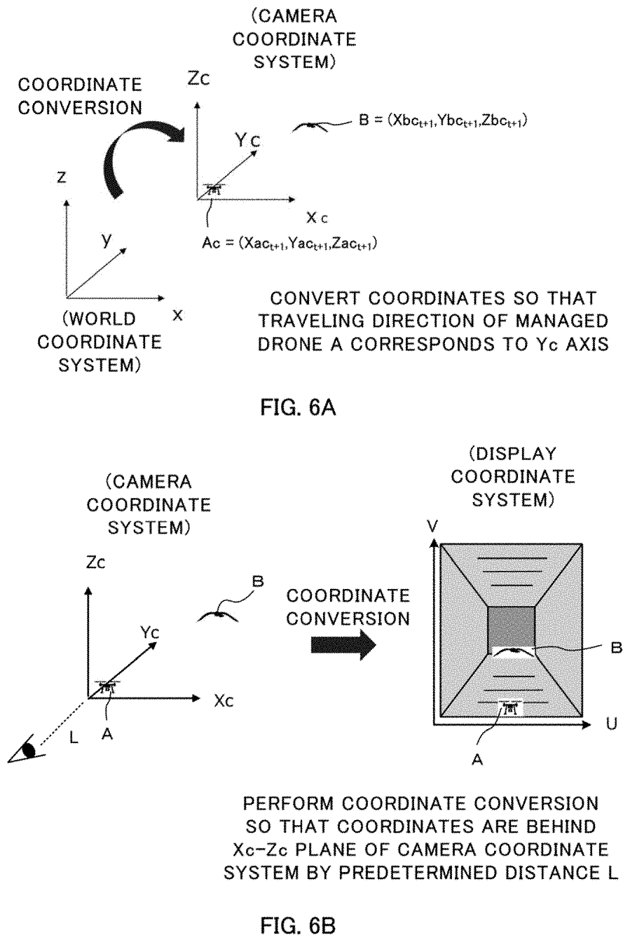

The display image creation unit 12 creates a display image to be displayed on the display section 27. Specifically, the display image creation unit 12 creates a third person perspective image and a bird's-eye view image. First, the third person perspective image will be described. The third person perspective image is regarded as an image that displays the managed drone with the unmanaged flying object which is determined that there is the possibility of collision at a third person viewpoint. FIG. 6A and FIG. 6B are diagrams for explaining a method for creating the third person perspective image. First, as depicted in FIG. 6A, the display image creation unit 12 converts the world coordinate system into a camera coordinate system viewed from the managed drone A. Note that the world coordinate system corresponds to a coordinate system of the entire area managed by the drone management apparatus 10, and the three-dimensional coordinates included in the unmanaged object information are regarded as coordinates in the world coordinate system. In this coordinate conversion, the display image creation unit 12 performs a coordinate conversion so that the traveling direction of the managed drone A corresponds to a Yc axis of the camera coordinate system. Note that the camera coordinate system is regarded as a coordinate system in a case of assuming that a periphery of the position of the managed drone is viewed from the third person viewpoint.

Next, as illustrated in FIG. 6B, the display image creation unit 12 converts the obtained camera coordinate system into a display coordinate system U-V which views the Xc-Zc plane from a rear by a predetermined distance L. At this time, an origin of the display coordinate system U-V does not need to coincide with an origin of the camera coordinate system, and as depicted in FIG. 6B, the origin of the display coordinate system U-V may be determined so that the managed drone A comes near a center of a U axis of the display coordinate system. By this coordinate conversion, the display image creation unit 12 creates a third person perspective image in which the managed drone A and the unmanaged flying object B, for which it is determined there is a possibility of collision, are viewed from a rear of the managed drone A.

Furthermore, the display image creation unit 12 creates a bird's-eye view image indicating current positions and traveling directions of another managed drone and the unmanaged flying object existing around the managed drone A based on the unmanaged object information. After that, the display image creation unit 12 outputs the created third person perspective image and the created bird's-eye view image to the display control unit 13.

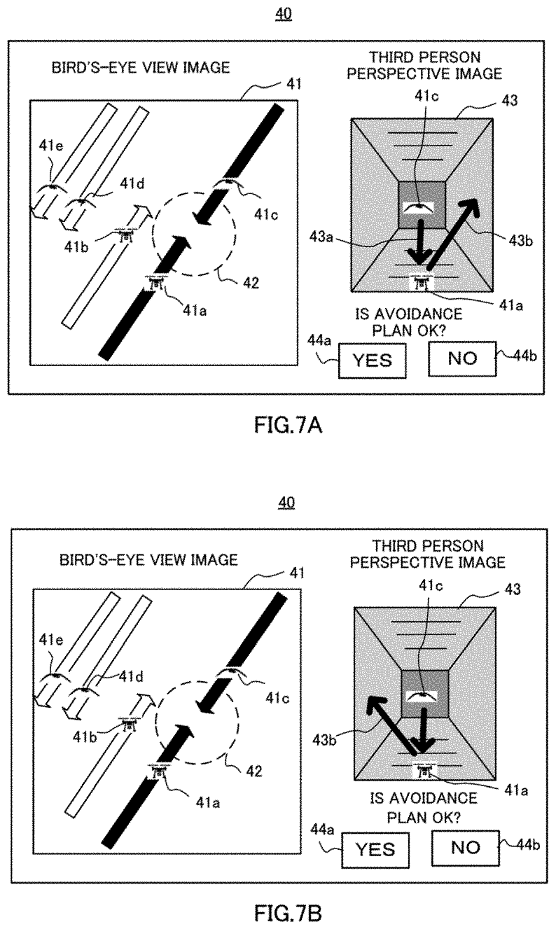

The display control unit 13 displays the third person perspective image and the bird's-eye view image, which are created by the display image creation unit 12, on the display section 27. FIG. 7A illustrates an example of a display image. A display image 40 includes a bird's-eye view image 41, and a third person perspective image 43.

The bird's-eye view image 41 is regarded as an image showing current positions and flight routes of the unmanaged flying objects and other managed drones existing in the periphery of the managed drone by a bird's-eye view from above. Note that the flight route includes portions predicted based on the flight route up to a current position. In FIG. 7A, managed drones 41a and 41b, and birds 41c through 41e, which are unmanaged flying objects, are displayed in the bird's-eye perspective image 41. Here, the managed drone 41a and the bird 41c are determined to be in a state where there is a possibility of collision as indicated by a dashed circle 42, that is, to correspond to the warning state, and their flight routes are indicated by black arrows. The dashed circle 42 corresponds to the warning distance d described above. On the other hand, another managed drone 41b and the birds 41d and 41e do not fall under the warning state, and these flight routes are indicated by white arrows. Note that, the managed drone and the unmanaged flying object that fall under the warning state may be indicated by red arrows, and the managed drone and the unmanaged flying object that do not fall under the warning state may be indicated by blue arrows, and both may be distinguishably displayed by color coding.

The third person perspective image 43 is regarded as an image obtained by the conversion to the display coordinate system depicted in FIG. 6B, and a three-dimensional image displayed so as that a depth becomes deeper toward a center portion. The third person perspective image 43 is basically displayed when the managed drone falls under the warning state, and the display ends when the managed drone no longer falls under the warning state. Therefore, when there is no managed drone falling to the warning state, basically third person perspective image 43 is not displayed.

As depicted in FIG. 7A, the third person perspective image 43 in a case of corresponding to the warning state displays the managed drone 41a, and the bird 41c being an unmanaged flying object having a possibility of collision. An arrow 43a from the bird 41c toward the managed drone 41a indicates a predicted direction of movement of the bird 41c, and implies that collision occurs in a case where both of them proceed as they are. Moreover, as indicated by an arrow 43b, the third person perspective image 43 in a case of corresponding to the warning state displays an avoidance plan for avoiding collision. The avoidance plan is determined by the collision possibility determination unit 11 based on a positional relationship between the managed drone and the unmanaged flying object corresponding to the warning state. In an example of FIG. 7A, since the managed drone 41a collides with the bird 41c when proceeding as it is, the drone management apparatus 10 displays the arrow 43b for changing a course to a right direction as an avoidance plan. In a case of displaying the avoidance plan, the drone management apparatus 10 displays buttons 44a and 44b for selecting and instructing whether or not to agree to the avoidance plan at the same time. A user (controller) presses the button 44a to agree with the avoidance plan indicated by the arrow 43b, and presses the button 44b when the user does not agree. In a case where the user does not agree to the proposed avoidance plan, the drone management apparatus 10 proposes another avoidance plan. For instance, in a case where the user does not agree on the avoidance plan changing to the right direction indicated by the arrow 43b in FIG. 7A, the drone management apparatus 10 proposes the avoidance plan in a left direction as depicted by the arrow 43b in FIG. 7B. Note that the third person perspective image in a case of corresponding to the warning state is regarded as an example of a warning image in the present disclosure.

As described above, by displaying the third person perspective information when the managed drone falls under the warning state, it is possible for the user to take a necessary avoidance action after confirming the positional relationship between the managed drone and the unmanaged flying object with a high possibility of collision. Moreover, since the avoidance plan determined by the collision possibility determination unit 11 is proposed, it is possible for the user to instruct the appropriate avoidance action while also considering the proposed avoidance plan.

(Collision Avoidance Process)

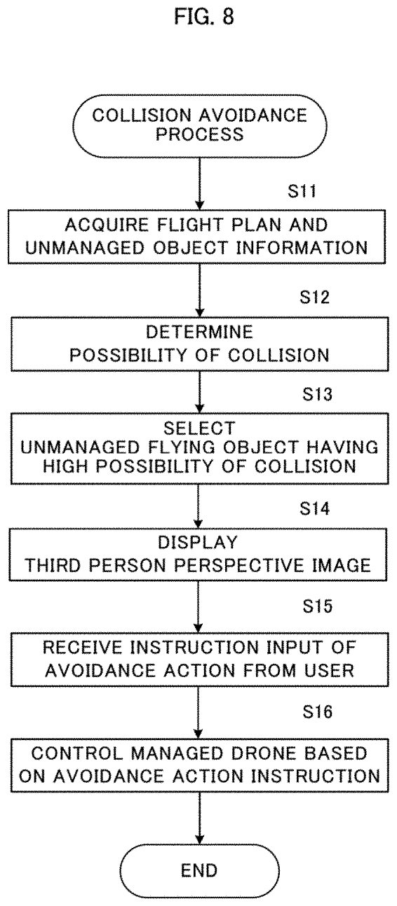

Next, a collision avoidance process by the drone management apparatus 10 will be described. FIG. 8 is a flowchart of the collision avoidance process. This process is realized by the processor 22 illustrated in FIG. 2, which executes a program prepared in advance, and operates as each element depicted in FIG. 1. Note that it is assumed that the drone management apparatus 10 acquires positions of unmanaged flying objects and other managed drones flying around the managed drone, and displays the bird's-eye view image 41 illustrated in FIG. 7 on the display section 27.

First, the collision possibility determination unit 11 acquires the flight plan of the managed drone from the flight plan storage unit 16, and acquires the unmanaged object information from the unmanaged object information storage unit 17 (step S11). Next, the collision possibility determination unit 11 determines the possibility of collision between the managed drone and the unmanaged flying object that is present in a periphery (step S12). Specifically, the collision possibility determination unit 11 determines whether or not the managed drone and the unmanaged flying object are within a predetermined warning distance d. After that, the collision possibility determination unit 11 selects the unmanaged flying object having a high collision possibility, that is, the unmanaged flying object corresponding to the warning state (step S13), and outputs information to the display control unit 13.

As described with reference to FIG. 5 and FIG. 6, the display control unit 13 performs the coordinate conversion from the world coordinate system to the camera coordinate system and the coordinate conversion from the camera coordinate system to the display coordinate system, creates a third person perspective image including the unmanaged flying object corresponding to the warning state, and displays the third person perspective image on the display section 27 (step S14). Accordingly, as illustrated in FIG. 7, the third person perspective image 43 including the avoidance plan is displayed.

When the user performs an instruction input of the avoidance action with respect to the display image 40 illustrated in FIG. 7, the operation acquisition unit 18 receives the instruction input, and outputs the instruction input to the drone management unit 14 (step S15). The drone management unit 14 transmits a control signal to the managed drone through the communication unit 15, and controls the managed drone in accordance to the avoidance action input by the user (step S16). By this control, the managed drone takes the avoidance action in accordance with the instruction of the user. After that, the collision avoidance process is terminated.

(Other Examples of the Display Image)

Next, other examples of the display image will be described.

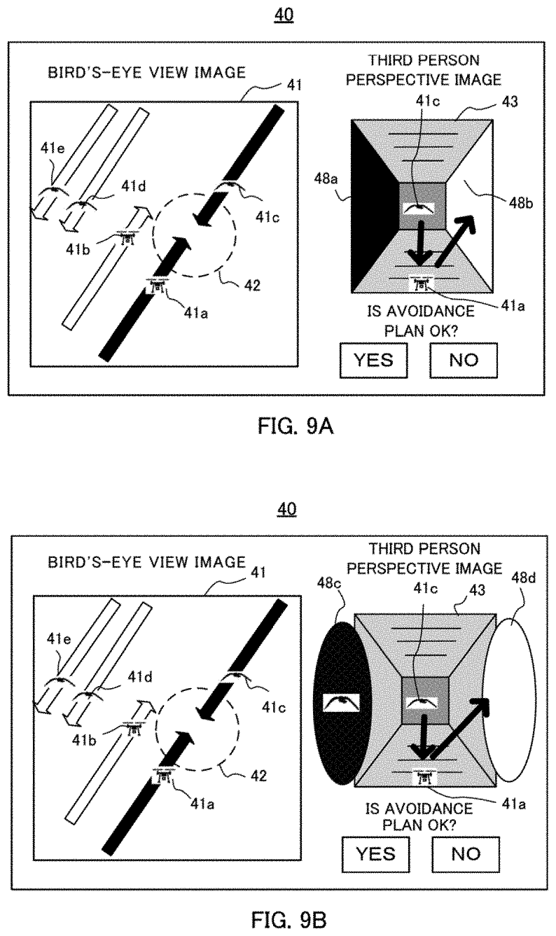

FIG. 9A illustrates another example of the third person perspective image in a case of falling under the warning state. This example illustrates whether the traveling direction is safe or danger in a case of avoiding a collision with an unmanaged flying object. Specifically, in the third person perspective image 43 of FIG. 9A, the area 48a on a left side of the unmanaged flying object 41c is displayed in black in order to indicate the area 48a as the dangerous area. On the other hand, the area 48b on a right side of the unmanaged flying object 41c is displayed in white, in order to indicate the area 48b as a safe zone. Instead of black and white, the dangerous area may be indicated in red, and the safe zone may be indicated in blue. In FIG. 9B, as another display example, a danger zone 48c in black is overlapped and displayed on a left side of the unmanaged flying object 41c, and a safe zone 48d in white is overlapped and displayed on the right side of the unmanaged flying object 41c. In this case, shapes of the danger zone 48c and the safe zone 48d to be displayed are not limited to an ellipse.

Note that it may be determined whether an area is the danger zone or the safe zone, based on whether or not there are other flying objects in each area. In examples of FIG. 9A and FIG. 9B, since another managed drone 41b and birds 41d and 41e exist on the left side of the managed drone 41a as depicted in the bird's-eye view image 41, the drone management apparatus 10 determines the left direction of the managed drone 41b as the danger zone. On the other hand, since there is no other flying object in the right direction of the managed drone 41a, the drone management apparatus 10 determines the right side of the managed drone 41a as the safe zone. Accordingly, the drone management apparatus 10 may display the danger zone and the safe zone as depicted in FIG. 9A and FIG. 9B based on the presence or absence of other flying objects in the periphery of the managed drone 41a. Note that, in the examples of FIG. 9A and FIG. 9B, the danger zone and the safe zone are displayed on the left and right of the unmanaged flying object 41c ; however, the danger zone and the safe zone may be displayed respectively above and below the unmanaged flying object 41c. Alternatively, instead of both the danger zone and the safe zone, either one of the areas may be displayed. As described above, the danger zone or the safe zone is displayed in third person perspective image in a case of falling under the warning state, and thus, it is possible for the user to select the avoidance plan considering whether there is no possibility of collision with other flying objects when avoiding the unmanaged flying objects which are likely to collide at present.

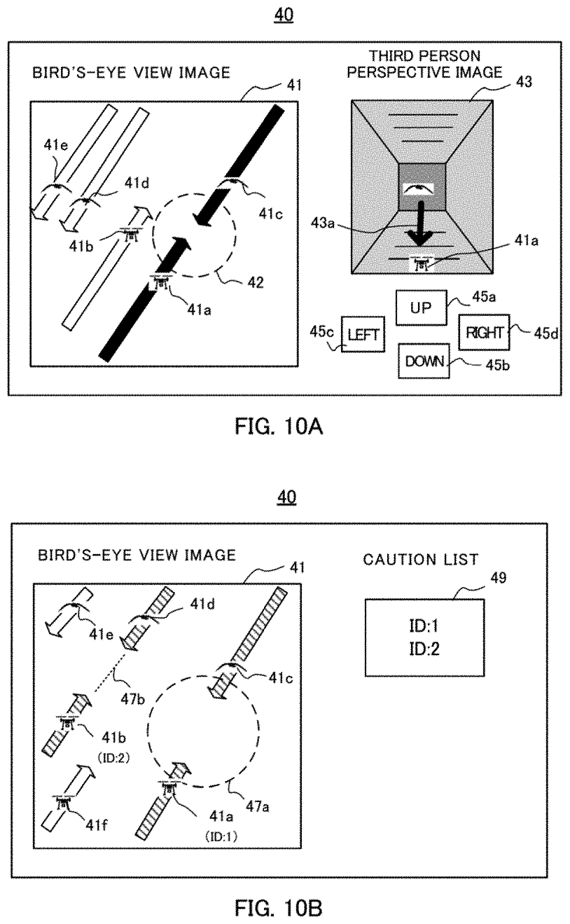

FIG. 10A illustrates another example of the third person perspective image in the case of falling under the warning state. In this example, the drone management apparatus 10 does not propose the avoidance plan, and instead displays buttons 45a through 45d indicating vertical and horizontal avoidance directions. The user may decide an avoidance direction by determination of the user, and may operate a corresponding button. Note that, as illustrated in FIG. 7A, the drone management apparatus 10 may first propose the avoidance plan, and may display buttons 45a through 45d indicating avoidance directions as depicted in FIG. 10A when the user does not agree on the avoidance plan. In addition, in a case where there is a four-way lever or an eight-way lever for instructing a traveling direction of the managed drone as the input unit 26 of the drone management apparatus 10, the display of the buttons 45a through 45d may be omitted.

FIG. 10B illustrates another example of the display image. As described above, in a case where a distance between the managed drone and the unmanaged flying object is within the warning distance d and falls into the warning state, the third person perspective image as depicted in FIG. 7 is displayed. However, even in a case where the managed drone does not fall under the warning state, it is effective to urge attention in advance for a case where it is likely to fall under the warning state in a near future. Accordingly, the drone management apparatus 10 determines whether or not the managed drone falls under a caution state, and displays that state when it falls under the caution state. Here, the “caution state” is regarded as a state that has no urgency as much as the warning state, but is likely to fall into the warning state with high probability in the future; for instance, a case where the distance between the managed drone and the unmanaged flying object is within a second distance p (hereinafter, also referred to as a “caution distance”) longer than the warning distance d, a case where the managed drone and the unmanaged flying object are proceeding in a direction approaching each other on the same straight line, a case where the traveling direction of the managed drone and the unmanaged flying object intersect, and the like are considered.

FIG. 10B illustrates an example of the display image in a case where the managed drone corresponds to the caution state. Although the bird's-eye view image 41 is basically the same as that described above, arrows of the managed drone and the unmanaged flying object corresponding to the caution state are displayed in color, line type, line thickness, or the like indicating the caution state, and are distinguishably displayed from a managed drone and an unmanaged flying object not falling under the caution state. In the example of FIG. 10B, the managed drone 41a (assuming ID: 1) and the unmanaged flying object 41c correspond to the caution state, an arrow indicating the flight route thereof is indicated by hatching of diagonal lines. Note that a circle 47a of a broken line corresponds to the caution distance p, and indicates that the managed drone 41a and the unmanaged flying object 41c are within the caution distance p. Similarly, the managed drone 41b (assuming ID: 2) and the unmanaged flying object 41d fall under the caution state, and arrows indicating those flight routes are depicted by hatching of diagonal lines. Note that a broken line 47b indicates that the managed drone 41b and the unmanaged flying object 41d are on the same straight line. On the other hand, the managed drone 41f and the unmanaged flying object 41e do not fall under the caution state, and these flight routes are indicated by white arrows. In practice, it is preferable that the arrows indicating the flight routes of the managed drone and the unmanaged flying object corresponding to the caution state are depicted in yellow and the arrows indicating the flight routes of the managed drone and the unmanaged flying object not corresponding to the caution state are depicted in blue.

As described above, in a case where there is managed drones corresponding to the caution state, the drone management apparatus 10 displays a caution list 49 as illustrated in FIG. 10B. The caution list 49 includes IDs of the managed drones which fall under the caution state. By the caution list 49, it is possible for the user to carefully monitor the managed drones that do not fall under the warning state but fall under the caution state.

In a case where a managed drone corresponding to the warning state and a drone corresponding to the caution state are present at the same time, the drone management apparatus 10 may display both drones at the same time in the bird's-eye view image 41. In this case, it is preferable that arrows indicating respective flight routes of the managed drone and the unmanaged flying object, which correspond to the warning state, are indicated in red, arrows indicating respective flight routes of the managed drone and the unmanaged flying object, which correspond to the caution state, are indicated in yellow, and arrows indicating respective flight routes of the managed drone and the unmanaged flying object, which do not correspond to either state, are indicated in blue. In addition, in a case where the managed drone corresponding to the warning state and the drone corresponding to the caution state are present at the same time, the drone management apparatus 10 may preferentially display the third person perspective image indicating the managed drone corresponding to the warning state and the unmanaged flying object, and does not display the caution list or may display the caution list in a small size.

Moreover, in the above example, the drone management apparatus 10 automatically displays the third person perspective image in a case where the managed drone corresponds to the warning state, and the third person perspective image is not displayed in a case where the managed drone corresponding to the warning state does not exist. Alternatively, the drone management apparatus 10 may display a third person perspective image for the managed drone selected by the user in a case where there is no managed drone corresponding to the warning state. For instance, when the user selects an arbitrary management drone displayed on the third person perspective image 41 by clicking with a mouse, the drone management apparatus 10 may display a third person perspective image of the management drone.

Moreover, as illustrated in FIG. 10B, in a case where there is a managed drone corresponding to the caution state, when the user selects the managed drone corresponding to the caution state on the bird's-eye view image 41 or selects the ID of the managed drone in the caution list 49, the drone management apparatus 10 may display a third person perspective image of the managed drone. The third person perspective image for the managed drone that falls under the caution state is basically the same as the third person perspective image for the managed drone that falls under the warning state except for that the managed drone is far from the unmanaged flying object. Note that the third person perspective image of the managed drone which does not fall under either of the warning state and the caution state corresponds to basically an image in which only the managed drone is displayed.

In examples of FIG. 7, FIG. 9, FIG. 10A, the third person perspective image is an image viewed from a position of a viewpoint which is behind the managed drone on a line connecting the managed drone and the unmanaged flying object; however, the position of the viewpoint in the third person perspective image may be arbitrarily changed by the user. In this case, buttons such as the vertical and horizontal selection buttons 45a through 45d depicted in FIG. 10A may be provided for changing a viewpoint, or a lever or the like in four or eight directions may be provided in order to accept an operation of a viewpoint change by the user. Accordingly, for instance, it is possible for the user to change the position of the viewpoint vertically and horizontally with respect to the managed drone, and to view the third person perspective image from any direction.

In the above example, an instruction for avoiding collision with the unmanaged flying object is performed using a keyboard, a mouse, a dedicated lever, or the like in the warning state; alternatively or additionally, an instruction of the avoidance action may be performed by a voice input.

In the above example, the bird's-eye view image and the third person perspective image may be created by CG (Computer Graphics) or the like, or an actual image captured by the camera may be used. In this case, a satellite image or the like can be used as the bird's-eye view image, and a captured image by a camera mounted on the managed drone can be used as the third person perspective image.

### Second Example Embodiment

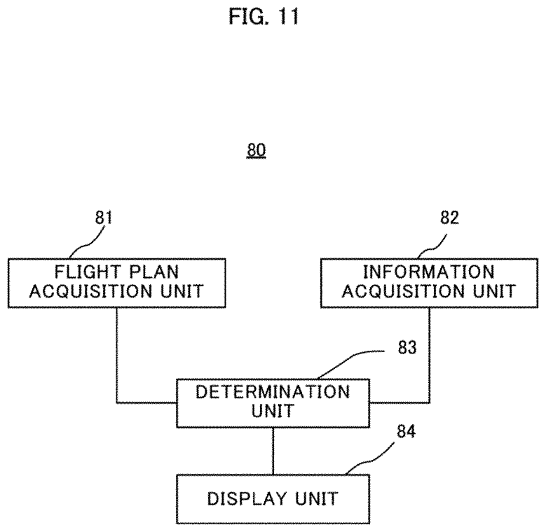

FIG. 11 is a block diagram illustrating a configuration of a flying object management apparatus according to a second example embodiment. A flying object management apparatus 80 includes a flight plan acquisition unit 81, an information acquisition unit 82, a determination unit 83, and a display unit 84. The flight plan acquisition unit 81 acquires a flight plan of a managed flying object, which is a flying object to be managed. The information acquisition unit 82 acquires information of an unmanaged flying object which is a flying object other than the managed flying object. The determination unit 83 determines a possibility of collision between the unmanaged flying object and the managed flying object based on the information of the unmanaged flying object and the flight plan. The display unit 84 displays a warning image including the unmanaged flying object which may collide with the managed flying object.

A part or all of the example embodiments described above may also be described as the following supplementary notes, but not limited thereto.

(Supplementary note 1)

1. A flying object management apparatus comprising:

a flight plan acquisition unit configured to acquire a flight plan of a managed flying object being a flying object to be managed;

an information acquisition unit configured to acquire information of an unmanaged flying object being a flying object other than the managed flying object;

a determination unit configured to determine a possibility of collision between the unmanaged flying object and the managed flying object based on the information of the unmanaged flying object and the flight plan; and

a display unit configured to display a warning image including the unmanaged flying object having the possibility of collision.

(Supplementary note 2)

2. The flying object management apparatus according to supplementary note 1, wherein the warning image is a third person perspective image that views the managed flying object and the unmanaged flying object having the possibility of collision, from behind the managed flying object.

(Supplementary note 3)

3. The flying object management apparatus according to supplementary note 1 or 2, wherein the display unit displays the warning image when the managed flying object and the unmanaged flying object are in a state representing the possibility of collision, and ends displaying of the warning image in a state attaining no longer in the possibility of collision.

(Supplementary note 4)

4. The flying object management apparatus according to any one of supplementary notes 1 through 3, wherein the display unit presents, in the warning image, a flight plan for avoiding collision with the unmanaged flying object.

(Supplementary note 5)

5. The flying object management apparatus according to any one of supplementary notes 1 through 4, wherein the display unit displays, in the warning image, information indicating whether or not another unmanaged flying object is present in a direction for avoiding the unmanaged flying object.

(Supplementary note 6)

6. The flying object management apparatus according to any one of supplementary notes 1 through 4, wherein the display unit displays buttons for instructing a flight direction of the managed flying object.

(Supplementary note 7)

7. The flying object management apparatus according to any one of supplementary notes 1 through 6, wherein the determination unit is configured to

determine that a warning state has been attained when the unmanaged flying object and the managed flying object are within a first distance given in advance, and display the warning image including the unmanaged flying object; and

determine that a caution state has been attained when the unmanaged flying object and the managed flying object are within a second distance longer than the first distance or when the unmanaged flying object and the managed flying object are proceeding in a mutually approaching direction on the same line, in which the caution state does not correspond to the warning state, and display a caution list indicating identification information of managed flying objects that correspond to the caution state.

(Supplementary note 8)

8. The flying object management apparatus according to supplementary note 7, wherein the display unit displays the third person perspective image including the managed flying object and the unmanaged flying object the corresponds to the caution state with respect to the managed flying object, when the managed flying object included in the caution list is designated.

(Supplementary note 9)

9. The flying object management apparatus according to supplementary note 7 or 8, wherein

the display unit displays a bird's-eye view image representing positions and traveling directions of the managed flying object and the unmanaged flying object which are present within a predetermined range from the managed flying object; and

the display unit displays, in a distinguishable form in the bird's-eye view image, a managed flying object that corresponds to the warning state, a managed flying object that corresponds to the caution state, and a managed flying object that does not correspond to either of the warning state and the caution state.

(Supplementary note 10)

10. A flying object management method comprising:

acquiring a flight plan of a managed flying object being a flying object to be managed;

acquiring information of an unmanaged flying object being a flying object other than the managed flying object;

determining a possibility of collision between the unmanaged flying object and the managed flying object based on the information of the unmanaged flying object and the flight plan; and

displaying a warning image including the unmanaged flying object having the possibility of collision.

(Supplementary note 11)

11. The flying object management method according to supplementary note 10, wherein the warning image is a third person perspective image that views the managed flying object and the unmanaged flying object having the possibility of collision from behind the managed flying object.

(Supplementary note 12)

12. The flying object management method according to supplementary note 10 or 11, further comprising displaying the warning image when the managed flying object and the unmanaged flying object are in a state representing the possibility of collision, and ending displaying of the warning image in a state attaining no longer in the possibility of collision.

(Supplementary note 13)

13. The flying object management method according to any one of supplementary notes 10 through 12, wherein the warning image presents a flight plan for avoiding collision with the unmanaged flying object.

(Supplementary note 14)

14. The flying object management method according to any one of supplementary notes 10 through 13, wherein the warning image includes information indicating whether or not another unmanaged flying object is present in a direction for avoiding the unmanaged flying object.

(Supplementary note 15)

15. The flying object management method according to any one of supplementary notes 10 through 14, further comprising displaying buttons for instructing a flight direction of the managed flying object.

(Supplementary note 16)

16. The flying object management method according to any one of supplementary notes 10 through 15, further comprising

determining that a warning state has been attained when the unmanaged flying object and the managed flying object are within a first distance given in advance, and displaying the warning image including the unmanaged flying object; and

determining that a caution state has been attained when the unmanaged flying object and the managed flying object are within a second distance longer than the first distance or when the unmanaged flying object and the managed flying object are proceeding in a mutually approaching direction on the same line, in which the caution state does not correspond to the warning state, and displaying a caution list indicating identification information of managed flying objects that correspond to the caution state.

(Supplementary note 17)

17. The flying object management method according to supplementary note 16, further comprising displaying the third person perspective image including the managed flying object and the unmanaged flying object that corresponds to the caution state with respect to the managed flying object, when the managed flying object included in the caution list is designated.

(Supplementary note 18)

18. The flying object management method according to supplementary note 16 or 17, further comprising:

displaying a bird's-eye view image representing positions and traveling directions of the managed flying object and the unmanaged flying object which are present within a predetermined range from the managed flying object; and

displaying, in a distinguishable form in the bird's-eye view image, a managed flying object that corresponds to the warning state, a managed flying object that corresponds to the caution state, and a managed flying object that does not correspond to either of the warning state and the caution state.

(Supplementary note 19)

19. A recording medium storing a program, the program causing a computer to perform a process comprising:

acquiring a flight plan of a managed flying object being a flying object to be managed;

acquiring information of an unmanaged flying object being a flying object other than the managed flying object;

determining a possibility of collision between the unmanaged flying object and the managed flying object based on the information of the unmanaged flying object and the flight plan; and

displaying a warning image including the unmanaged flying object having the possibility of collision.

(Supplementary note 20)

20. The recording medium according to supplementary note 19, wherein the warning image is a third person perspective image that views the managed flying object and the unmanaged flying object having the possibility of collision from behind the managed flying object.

While the invention has been described with reference to the example embodiments and examples, the invention is not limited to the above example embodiments and examples. It will be understood by those of ordinary skill in the art that various changes in form and details may be made therein without departing from the spirit and scope of the present invention as defined by the claims.

### DESCRIPTION OF SYMBOLS

10 Drone management apparatus

11 Collision possibility determination unit

12 Display image creation unit

13 Display control unit

14 Drone control unit

15 Communication unit

16 Flight plan storage unit

17 Unmanaged object information unit

18 Operation acquisition unit

41 Bird's-eye view image

43 Third person perspective image

70 Flying object detection apparatus

100 Drone control system

What is claimed is:

1. A flying object management apparatus comprising:
a memory storing instructions; and
one or more processors configured to execute the instructions to:
acquire a flight plan of a managed flying object being a flying object to be managed;
acquire information of an unmanaged flying object being a flying object other than the managed flying object;
determine a possibility of collision between the unmanaged flying object and the managed flying object based on the information of the unmanaged flying object and the flight plan; and
display a warning image including the unmanaged flying object having the possibility of collision.

2. The flying object management apparatus according to claim 1, wherein the warning image is a third person perspective image that views the managed flying object and the unmanaged flying object having the possibility of collision from behind the managed flying object.

3. The flying object management apparatus according to claim 1, wherein the processor displays the warning image when the managed flying object and the unmanaged flying object are in a state representing the possibility of collision, and ends displaying of the warning image in a state attaining no longer in the possibility of collision.

4. The flying object management apparatus according to claim 1 wherein the processor presents, in the warning image, a flight plan for avoiding collision with the unmanaged flying object.

5. The flying object management apparatus according to claim 1 wherein the processor displays, in the warning image, information indicating whether or not another unmanaged flying object is present in a direction for avoiding the unmanaged flying object.

6. The flying object management apparatus according to claim 1 wherein the processor displays buttons for instructing a flight direction of the managed flying object.

7. The flying object management apparatus according to claim 1 wherein the processor is configured to
determine that a warning state has been attained when the unmanaged flying object and the managed flying object are within a first distance given in advance, and display the warning image including the unmanaged flying object; and
determine that a caution state has been attained when the unmanaged flying object and the managed flying object are within a second distance longer than the first distance or when the unmanaged flying object and the managed flying object are proceeding in a mutually approaching direction on the same line, in which the caution state does not correspond to the warning state, and display a caution list indicating identification information of managed flying objects that correspond to the caution state.

8. The flying object management apparatus according to claim 7, wherein the processor displays the third person perspective image including the managed flying object and the unmanaged flying object that corresponds to the caution state with respect to the managed flying object, when the managed flying object included in the caution list is designated.

9. The flying object management apparatus according to claim 7, wherein
the processor displays a bird's-eye view image representing positions and traveling directions of the managed flying object and the unmanaged flying object which are present within a predetermined range from the managed flying object; and
the processor displays, in a distinguishable form in the bird's-eye view image, a managed flying object that corresponds to the warning state, a managed flying object that corresponds to the caution state, and a managed flying object that does not correspond to either of the warning state and the caution state.

10. A flying object management method comprising:
acquiring a flight plan of a managed flying object being a flying object to be managed;
acquiring information of an unmanaged flying object being a flying object other than the managed flying object;
determining a possibility of collision between the unmanaged flying object and the managed flying object based on the information of the unmanaged flying object and the flight plan; and
displaying a warning image including the unmanaged flying object having the possibility of collision.

11. The flying object management method according to claim 10, wherein the warning image is a third person perspective image that views the managed flying object and the unmanaged flying object having the possibility of collision from behind the managed flying object.

12. The flying object management method according to claim 10, further comprising displaying the warning image when the managed flying object and the unmanaged flying object are in a state representing the possibility of collision, and ending displaying of the warning image in a state attaining no longer in the possibility of collision.

13. The flying object management method according to claim 10, wherein the warning image presents a flight plan for avoiding collision with the unmanaged flying object.

14. The flying object management method according to claim 10, wherein the warning image includes information indicating whether or not another unmanaged flying object is present in a direction for avoiding the unmanaged flying object.

15. The flying object management method according to claim 10, further comprising displaying buttons for instructing a flight direction of the managed flying object.

16. The flying object management method according to claim 10, further comprising
determining that a warning state has been attained when the unmanaged flying object and the managed flying object are within a first distance given in advance, and displaying the warning image including the unmanaged flying object; and
determining that a caution state has been attained when the unmanaged flying object and the managed flying object are within a second distance longer than the first distance or when the unmanaged flying object and the managed flying object are proceeding in a mutually approaching direction on the same line, in which the caution state does not correspond to the warning state, and displaying a caution list indicating identification information of managed flying objects that correspond to the caution state.

17. The flying object management method according to claim 16, further comprising displaying the third person perspective image including the managed flying object and the unmanaged flying object that corresponds to the caution state with respect to the managed flying object, when the managed flying object included in the caution list is designated.

18. The flying object management method according to claim 16, further comprising:
displaying a bird's-eye view image representing positions and traveling directions of the managed flying object and the unmanaged flying object which are present within a predetermined range from the managed flying object; and
displaying, in a distinguishable form in the bird's-eye view image, a managed flying object that corresponds to the warning state, a managed flying object that corresponds to the caution state, and a managed flying object that does not correspond to either of the warning state and the caution state.

19. A non-transitory computer-readable medium storing a program, the program causing a computer to perform a process comprising:
acquiring a flight plan of a managed flying object being a flying object to be managed;
acquiring information of an unmanaged flying object being a flying object other than the managed flying object;
determining a possibility of collision between the unmanaged flying object and the managed flying object based on the information of the unmanaged flying object and the flight plan; and
displaying a warning image including the unmanaged flying object having the possibility of collision.

20. The recording medium according to claim 19, wherein the warning image is a third person perspective image that views the managed flying object and the unmanaged flying object having the possibility of collision from behind the managed flying object.
